(19) United States
(12) Patent Application Publication
(10) Pub. No.: US 2023/0038198 A1
(43) Pub. Date: Feb. 9, 2023

(54) DYNAMIC WIRELESS NETWORK THROUGHPUT ADJUSTMENT

(71) Applicant: AT&T Intellectual Property I, L.P., Atlanta, GA (US)

(72) Inventors: David Lewis, Freehold, NJ (US); Feza Buyukdura, Fairview, TX (US); Weihua Ye, Chicago, IL (US); Baofeng Jiang, Pleasanton, CA (US)

(21) Appl. No.: 17/392,932

(22) Filed: Aug. 3, 2021

(51) Int. Cl. H04L 12/801; H04L 12/26

(52) U.S. Cl. CPC H04L 47/12; H04L 43/0888

(57) ABSTRACT

Dynamic wireless network throughput adjustment is provided herein. A method can include determining, by a system comprising a processor, a sector of a communication network for which an amount of congestion present in the sector is greater than a congestion threshold; selecting, by the system from among respective network equipment operating in the sector, target network equipment for throughput adjustment based on equipment performance metrics respectively associated with the respective network equipment; and facilitating, by the system, adjusting a throughput of the target network equipment by an adjustment amount determined based on target equipment performance metrics, of the equipment performance metrics, associated with the target network equipment.

### TECHNICAL FIELD

The present disclosure relates to communication networks, and, in particular, to techniques for adjusting throughput of devices and/or sessions in a communication network.

### BACKGROUND

In wireless communication networks, Aggregate Maximum Bit Rate (AMBR) can be defined as a measure of the total throughput available to a device and/or or to an individual data connection on a device. In general, an AMBR can be configured for a given service or package of services to which a device subscribes. As AMBR represents a maximum bit rate, it can therefore operate as an upper limit to the throughput attainable by a device for communications relating to a service or group of services assigned to an AMBR value.

### DESCRIPTION OF DRAWINGS

FIG. 1 is a block diagram of a system that facilitates dynamic wireless network throughput adjustment in accordance with various aspects described herein.

FIG. 2 is a block diagram that depicts example functionality of the resource controller device of FIG. 1 in accordance with various aspects described herein.

FIGS. 3-4 are block diagrams of respective systems that facilitate distributed computation and enforcement of network throughput adjustments in accordance with various aspects described herein.

FIGS. 5-6 are diagrams depicting respective network environments in which the embodiments shown in FIGS. 3-4 can function.

FIG. 7 is a block diagram of a system that facilitates localized computation and enforcement of network throughput adjustments in accordance with various aspects described herein.

FIGS. 8-9 are diagrams depicting respective network environments in which the resource controller device of FIG. 7 can function.

FIG. 10 depicts an example network architecture in which various embodiments described herein can function.

FIG. 11 is a flow diagram of a method that facilitates dynamic wireless network throughput adjustment in accordance with various aspects described herein.

FIG. 12 depicts an example computing environment in which various embodiments described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring certain aspects.

In an aspect, a method as described herein can include determining, by a system including a processor, a sector of a communication network based on an amount of congestion present in the sector. The method can further include selecting, by the system from among respective network equipment operating in the sector, target network equipment for throughput adjustment based on equipment performance metrics respectively associated with the respective network equipment. The method can additionally include facilitating, by the system, adjusting a throughput of the target network equipment by an adjustment amount determined based on target equipment performance metrics, of the equipment performance metrics, associated with the target network equipment.

In another aspect, a system as described herein can include a processor and a memory that stores executable instructions that, when executed by the processor, facilitate performance of operations. The operations can include determining a sector of a communication network based on an amount of network congestion exhibited by the sector; selecting, from among respective network devices operating in the sector, a target network device for throughput adjustment based on device performance metrics respectively associated with the respective network devices; and adjusting a throughput of the target network device by an adjustment amount, wherein the adjustment amount is determined based on a group of the device performance metrics associated with the target network device.

In a further aspect, a non-transitory machine-readable medium as described herein can include executable instructions that, when executed by a processor, facilitate performance of operations. The operations can include selecting a cell of a network based on an amount of congestion exhibited by the cell; selecting, from among respective network equipment operating in the cell, network equipment based on performance metrics respectively associated with the respective network equipment; and causing adjustment of a throughput of the network equipment by an adjustment amount, the adjustment amount being determined based on ones of the performance metrics associated with the network equipment.

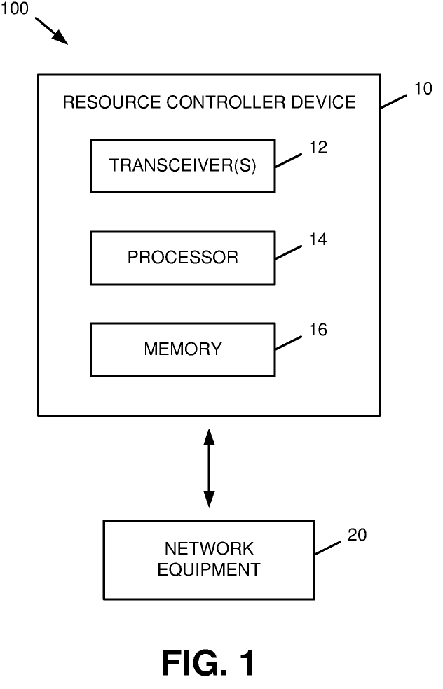

Referring first to FIG. 1, a system 100 that facilitates dynamic wireless network throughput adjustment is illustrated. System 100 as shown by FIG. 1 includes a resource controller device 10 that can communicate with network equipment 20 associated with a communication network. In an aspect, the resource controller device 10 and the network equipment 20 can form at least a portion of a wireless communication network. While only one resource controller device 10 and one network equipment 20 are illustrated in FIG. 1 for simplicity of illustration, it is noted that a wireless communication network can include any amount of resource controller devices 10, network equipment 20, and/or other devices.

In an aspect, the resource controller device 10 shown in system 100 can be implemented by one or more elements of a radio access network (RAN), such as an eNodeB (eNB), gNodeB (gNB), or other network access point, a RAN controller device, and/or any other device(s) of the RAN that can implement controls on communication resources utilized by the network equipment 20. Alternatively, the resource controller device 10 can be implemented by one or more devices that communicate with elements of the RAN, such as an Element Management System (EMS), network elements utilizing the Open Network Automation Platform (ONAP) Service Management and Orchestration architecture, or the like.

In still another example, the resource controller device 10 can be implemented via a server or other computing device that can communicate with elements of the RAN in which the network equipment 20 operates and/or other networks, such as a core network that is connected to the RAN, via one or more networks or internetworks. By way of specific, non-limiting example, the resource controller device 10 could be implemented in this manner via a cloud application or service that communicates with network elements associated with the network equipment 20 via the Internet.

While the resource controller device 10 is shown in FIG. 1 as a single device, it is noted that the functionality of the resource controller device 10 as described herein could be distributed among multiple distinct devices that can communicate with each other over the wireless communication network and/or by other means, such as a backhaul link that facilitates direct communication between respective RAN devices. Other implementations could also be used.

In an aspect, the network equipment 20 shown in system 100 can include any suitable device(s) that can communicate over a wireless communication network associated with the resource controller device 10. Such devices can include, but are not limited to, cellular phones, computing devices such as tablet or laptop computers, autonomous vehicles, Internet of Things (IoT) devices, etc. Also or alternatively, the network equipment 20 could include a device such as a modem, a mobile hotspot, or the like, that provides network connectivity to another device (e.g., a laptop or desktop computer, etc.), which itself can be fixed or mobile. In still another example, the network equipment 20 could include devices, such as base stations, eNBs, gNBs, or the like, that facilitate access by other network equipment 20 to the communication network. Thus, in some implementations, a network access point could include some or all functionality of both the resource controller device 10 and the network equipment 20.

The resource controller device 10 shown in system 100 can include one or more transceivers 12 that can communicate with (e.g., transmit messages to and/or receive messages from) the network equipment 20 and/or other devices in system 100. The transceiver 12 can include respective antennas and/or any other hardware or software components (e.g., an encoder/decoder, modulator/demodulator, etc.) that can be utilized to process signals for transmission and/or reception by the resource controller device 10 and/or associated network devices. While the resource controller device 10 and network equipment 20 are illustrated in system 100 as engaging in direct communications, it is noted that the resource controller device 10 could also be configured to conduct direct communications with a limited subset of the network equipment 20, such as network access points or the like, without directly communicating with other network equipment 20.

In an aspect, the resource controller device 10 can further include a processor 14 and a memory 16, which can be utilized to facilitate various functions of the resource controller device 10. For instance, the memory 16 can include a non-transitory computer readable medium that contains computer executable instructions, and the processor 14 can execute instructions stored by the memory 16. For simplicity of explanation, various actions that can be performed via the processor 14 and the memory 16 of the resource controller device 10 are shown and described below with respect to various logical components. In an aspect, the components described herein can be implemented in hardware, software, and/or a combination of hardware and software. For instance, a logical component as described herein can be implemented via instructions stored on the memory 16 and executed by the processor 14. Other implementations of various logical components could also be used, as will be described in further detail where applicable.

In an aspect, the processor 14 and the memory 16 of the resource controller device 10 can facilitate dynamic modification of the maximum throughput level available to a wireless device in response to network conditions, e.g., an associated wireless network experiencing a threshold amount of congestion. In addition, dynamic throughput modification can be facilitated by the processor 14 and the memory 16 of the resource controller device 10 based on other factors including device performance (e.g., signal strength and signal quality), device location, subscriber service category (e.g., first responder, mobility subscriber, fixed broadband subscriber, etc.), or the like.

By implementing the resource controller device 10 as described herein, various advantages can be realized that can improve the performance of a communication network. For instance, the resource controller device 10 can provide increased control over resource allocation across different categories of service during varying network conditions for different devices, e.g., relative to combinations of static priority levels. This can, in turn, protect higher-priority devices and/or users (e.g., first responders, mobility users) from excessive usage demand by lower-priority devices and/or users (e.g., fixed wireless broadband users) while still providing the lower-priority devices and/or users with improved service during periods and/or in locations where there is no network congestion. Other advantages are also possible.

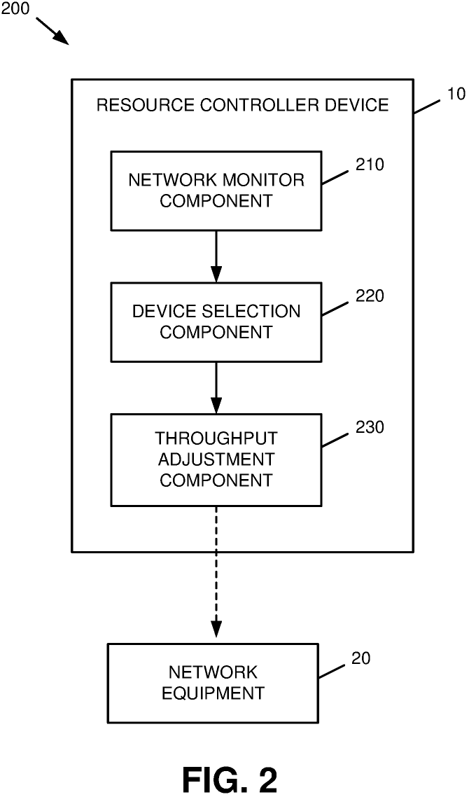

With reference now to FIG. 2, a block diagram of a system 200 that facilitates dynamic wireless network throughput adjustment is illustrated. Repetitive description of like elements employed in other embodiments described herein is omitted for brevity. System 200 as shown in FIG. 2 includes a resource controller device 10 that can operate in a similar manner to that described above with respect to FIG. 1. As shown in FIG. 2, the resource controller device 10 of system 200 can include a network monitor component 210 that can identify a region of a communication network, such as a cell, a sector, a portion of a cell such as a sector face, or the like, based on amount of congestion present in the region. In an aspect, the network monitor component 210 can perform this identification based on comparing the amount of congestion present in a given region of the communication network to a congestion threshold, e.g., such that the network monitor component 210 can identify a region in response to the congestion present in that region being greater than the congestion threshold. Also or alternatively, the network monitor component 210 could utilize predictive analysis, machine learning, and/or other techniques to identify a region of the communication network that is congested or overloaded with respect to a specific set of circumstances associated with that region (e.g., based on time of day, data traffic patterns, etc.), or are likely to become congested or overloaded. Other techniques could also be used by the network monitor component 210 in identifying network regions for further consideration by the resource controller device 10. By determining areas of a communication network that are congested or overloaded, the resource controller device 10, via the network monitor component 210, can selectively apply throughput adjustments to congested and/or overloaded areas of the network while not impacting other areas of the network that are not experiencing overloading or congestion.

In an aspect, the network monitor component 210 of the resource controller device 10 can determine an amount of congestion present in a given region of a communication network based on metrics of RAN, core network, and/or transport network performance. These metrics can include, but are not limited to, as physical resource block (PRB) utilization and/or availability, control channel load or utilization, the number of active devices or active bearers and/or data flows in a given network region, an aggregate cell bit rate associated with a given region, packet loss and/or delay statistics, or the like. It is noted, however, that the network monitor component 210 could utilize any suitable metric or combination of metrics, either presently known or developed in the future, for measuring congestion associated with one or more regions of the communication network.

As further shown in FIG. 2, the resource controller device 10 of system 200 can include a device selection component 220 that can select, from among respective ones of the network equipment 20 that are operating in a sector or other region of the communication network as identified by the network monitor component 210, target network equipment for throughput adjustment. In an aspect, the device selection component 220 can select target network equipment from among the network equipment 20 shown in system 200 based on equipment performance metrics that are respectively associated with the network equipment 20.

Equipment performance metrics that can be utilized by the device selection component 220 can include, e.g., Cell Quality Indicator (CQI), Signal-to-Noise Ratio (SNR) or Signal to Interference-plus-Noise Ratio (SINR), Reference Signal Received Power (RSRP) or Reference Signal Received Quality (RSRQ), UE-specific measures of throughput, delay, and/or packet loss, and/or other suitable metrics. Other factors that can be utilized by the device selection component 220 in selecting target network equipment can include a location of the target network equipment, either in absolute terms (e.g., latitude/longitude coordinates, etc.) or in relative terms (e.g., a distance of the target network equipment from a serving cell tower, etc.).

Also or alternatively, the device selection component 220 can select target network equipment based on a service category, such as a subscriber and/or device service category, assigned to the target network equipment. For instance, the device selection component 220 can select target network equipment of a specific service category for throughput adjustment to reduce the impact of that service category on network equipment associated with other service categories. By way of specific, non-limiting example, the device selection component 220 can select one or more devices associated with fixed wireless service (FWS) subscribers for throughput adjustment in order to improve the availability of network resources for devices associated with other service categories, such as emergency service responders, mobility subscribers, or the like, in order to maintain minimum levels of service provided by service level agreements (SLAs) or other policies associated with the respective service categories and/or to otherwise protect devices of the other service categories from service degradation caused by disproportionate usage of network resources by the FWS subscriber devices.

As another example, the device selection component 220 can select target network equipment in response to instances of focused network overload. For instance, in the event of a disaster or other public emergency, the device selection component 220 can prioritize access by first responders and/or other preauthorized devices to network resources in the area of the emergency while deprioritizing access to network resources by other users in the area. Other examples are also possible.

As additionally shown in FIG. 2, the resource controller device 10 of system 200 can include a throughput adjustment component 230 that can facilitate adjusting a throughput of target network equipment, e.g., target network equipment selected by the device selection component 220 as described above, by an adjustment amount. In an aspect, the adjustment amount can be determined based on target equipment performance metrics, which can be defined as a group of equipment performance metrics as identified by the device selection component 220 that specifically correspond to the target network equipment selected by the device selection component 220.

In an aspect, the throughput adjustment component 230 can adjust throughput for target network equipment by changing one or more Aggregate Maximum Bit Rate (AMBR) values associated with the target network equipment. As used herein, the general term AMBR can refer both to the total throughput available to a device (e.g., UE-AMBR) and to the total throughput available to an individual data connection on a device (e.g., Access Point Name AMBR or APN-AMBR, Session Maximum Bit Rate (Session MBR), etc.). It is noted that references made generally to adjusting “throughput” or “AMBR” of a given network device are intended to include both of the above types of throughput unless stated otherwise.

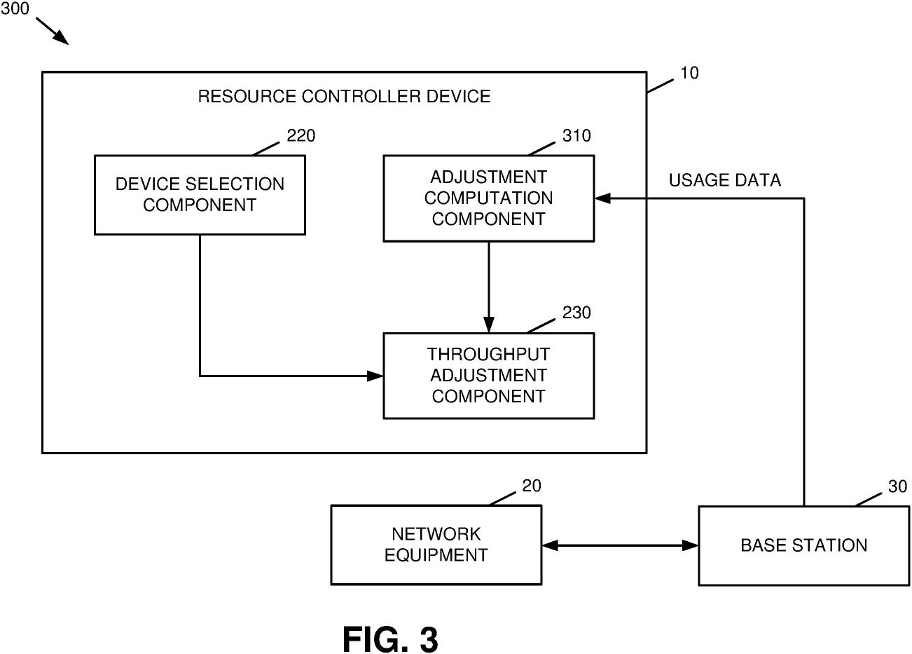

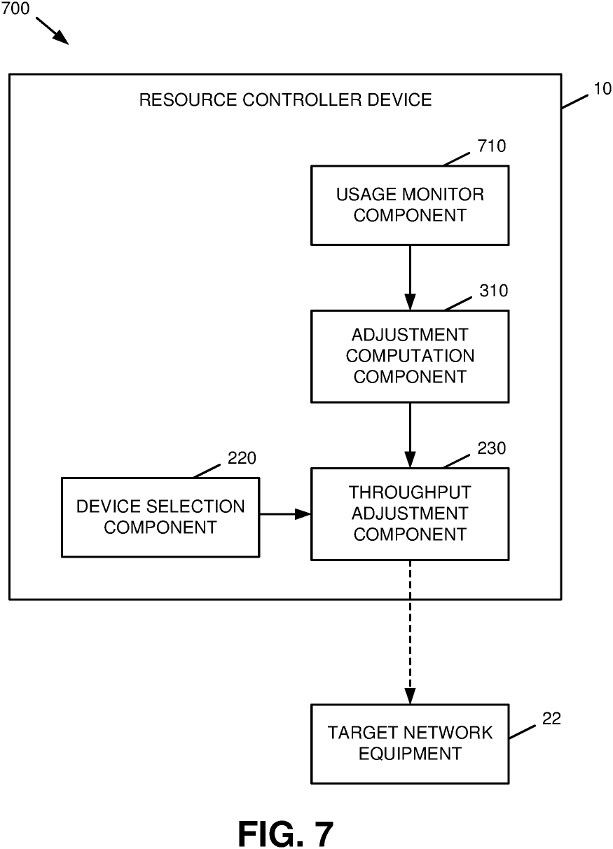

The throughput adjustment component 230 of the resource controller device 10 can, in respective implementations, facilitate adjustment of the throughput of target network equipment either indirectly, e.g., by instructing one or more other network elements to perform appropriate throughput adjustments, or directly, e.g., by itself altering the throughput assigned to given target network equipment. Techniques for indirect throughput adjustment are described in further detail below with respect to FIGS. 3-6, while techniques for direct throughput adjustment are described in further detail below with respect to FIGS. 7-9. Additionally, it is noted that the throughput adjustment component 230 could facilitate adjusting a throughput associated with given target network equipment via a combination of the direct and indirect adjustment techniques described below.

In an aspect, the resource controller device 10 shown in FIG. 2 can apply various techniques as described herein to mitigate degradation in service, e.g., across several or all categories of users of a communication network, associated with network congestion. Additionally, the resource controller device 10 can operate in a context-aware manner as described herein in order to prevent scenarios in which excessive network load can result in a condition where broad degradation of service across categories of users can result in the level of service dropping below a minimum usable threshold. As an example, downstream speeds of less than 0.5-1.0 Mb/s could be effectively unusable for even low-definition video streaming. Further, in a network environment in which different categories of users have different baseline demand on the network, the resource controller device 10 can operate as described herein to prevent scenarios in which broad degradation of service across categories of users could result in the throughput available to higher priority, but lower throughput, users dropping below a minimum usable threshold at a lower level of congestion than would occur for lower priority, but higher baseline throughput, users.

In addition, the resource controller device 10 as described herein can result in improvements to service quality that can be provided to lower priority users during times of low network load. By way of example, the resource controller device 10 can temporarily relax restrictions on video streaming services that limit video to a maximum bit rate, resolution, etc., if the network resources associated with streaming video would otherwise be underutilized due to low demand.

Turning now to FIG. 3, a block diagram of a system 300 that facilitates distributed computation and enforcement of network throughput adjustments is illustrated. Repetitive description of like elements employed in other embodiments described herein is omitted for brevity. System 300 as shown in FIG. 3 includes a resource controller device 10 that can include a device selection component 220 that can select network equipment 20 for throughput adjustment via a throughput adjustment component 230, e.g., as described above with respect to FIG. 2. In addition, the resource controller device 10 of system 300 can include an adjustment computation component 310 that can determine equipment performance metrics for respective network equipment 20, and/or adjustment amounts to be utilized by the throughput adjustment component 230 based on the equipment performance metrics, based on information obtained from various sources within the underlying communication network.

In the implementation shown by FIG. 3, the adjustment computation component 310 can obtain resource usage data from a base station 30 (eNB, gNB, access point, etc.) that serves respective network equipment 20. In an aspect, the resource usage data can be representative of respective amounts of resources, enabled via the communication network, that are being utilized by the respective network equipment 20. The adjustment computation component 310 can utilize additional information provided by the base station 30 and/or other network sources, such as signal strength or signal quality metrics associated with respective network equipment 20, location data associated with the network equipment, device or service subscription data associated with the network equipment 20, and/or other suitable information.

As further shown in FIG. 3, a base station 30 and/or other network data source can provide usage data and/or other information directly to the resource controller device 10 via the adjustment computation component 310 for generation of equipment performance metrics by the adjustment computation component 310. These metrics, in turn, can then be utilized by the device selection component 220 to determine target network equipment for throughput adjustment, as well as by the adjustment computation component 310 to generate appropriate throughput adjustment amounts.

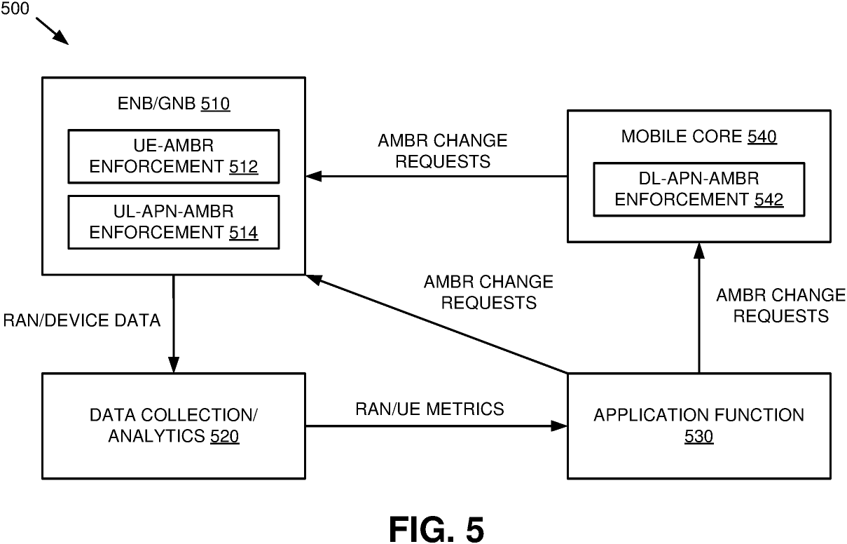

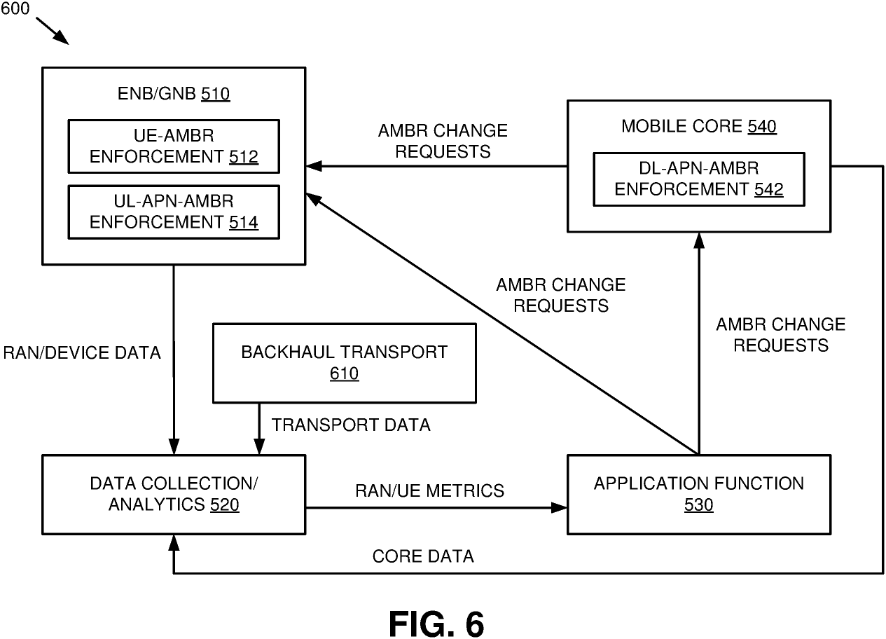

In an alternate implementation to that shown by FIG. 3, the base station 30, as well as other network elements such as transport network and/or core network elements, can pass information to a data collection and analytics system that is separate from the resource controller device 10, such that the equipment performance metrics as described above can be generated by the data collection and analytics system instead of the resource controller device 10. These equipment performance metrics can then be provided by the data collection and analytics system to the resource controller device 10, which can in turn facilitate throughput adjustment as described herein. An implementation with a standalone data collection and analytics system is described in further detail below with respect to FIGS. 5-6.

As noted above, the adjustment computation component 310 can facilitate adjustment of both a total throughput assigned to target network equipment, e.g., as defined by a UE AMBR parameter that defines a maximum throughput that can be utilized in aggregate by all sessions or data connections utilized by a given device. Also or alternatively, the adjustment computation component 310 can facilitate adjustment of a throughput assigned to a first session or data connection utilized by target network equipment, e.g., without adjusting or otherwise altering a throughput assigned to a second, different session or data connection utilized by the target network equipment. Adjustment of per-session throughput can be facilitated by the throughput adjustment component 230 on the basis of network slice or partition identifier associated with a given session, a data category associated with the session (e.g., voice, video, etc.), and/or any other criteria that can be utilized for distinguishing between data connections.

In an aspect, the adjustment computation component 310 can determine an adjustment amount to be applied to a throughput for a given device or class of devices (e.g., FWS users, etc.) based on network loading and/or congestion conditions. For instance, if the resource controller device 10 (e.g., via the network monitor component 210 shown in FIG. 2) determines that network congestion in a given area is at least a threshold value, the adjustment computation component 310 can facilitate an initial reduction of throughput to a selected device or class of devices. In the event that the observed congestion worsens, e.g., to a second, higher, or in the event that the observed congestion remains above a congestion threshold for a defined period of time, the adjustment computation component 310 can facilitate additional throughput reduction to the designated device or class of devices. Conversely, if the congestion abates, the adjustment computation component 310 can facilitate an increase in the throughput of the designated device or class of devices, e.g., to an originally allocated throughput.

By way of a specific, non-limiting example of the above, network equipment 20 associated with FWS users in the system can be assigned an initial AMBR of 50 megabits/second (Mb/s). Subsequently, if network congestion reaches a first threshold of 70%, the adjustment computation component 310 can facilitate reducing the AMBR of the FWS users from 50 Mb/s to 30 Mb/s. If the congestion persists for longer than a threshold time interval, or if the congestion increases from 70% to a second threshold of 80%, the adjustment computation component 310 could cause the AMBR of the FWS users to be further increased, e.g., from 30 Mb/s to 10 Mb/s.

While the above example describes throughput adjustments of a fixed amount, the adjustment computation component 310 could determine the amount of adjustment to be applied based on factors such as the number of users of a given user class that are using resources in a given region of the network, device location, usage or signal quality statistics, or the like. A non-exhaustive listing of example throughput adjustments that can be facilitated by the adjustment computation component 310, and/or the resource controller device 10 as a whole, are as follows:
1) Throughput can be reduced for devices with consistently poor signal strength or signal quality, e.g., to limit resource utilization by these devices due to lower-order encoding utilized in these conditions, which can result in lower spectral efficiency (e.g., higher physical resource use per bit transported). Conversely, throughput can be reduced for devices with consistently high signal strength or signal quality, e.g., to prevent underutilization of physical resources due to the higher spectral efficiency of such devices.
2) Throughput can be reduced for devices subscribing to a “fixed” service, e.g., a communication service associated with a registered service location, that have been determined by the network to have moved from the registered service location. Stated another way, the resource controller device 10 can provide geofencing-like capabilities by reducing the available throughput for fixed devices that have been moved from their service address.
3) Throughput can be increased, or protected from decrease, for devices in a prioritized service category on an ad-hoc basis. For instance, the resource controller device 10 can increase and/or protect the throughput of a first responder device or service during an emergency situation in a disaster area.
4) Throughput can be reduced for high-usage devices under situations of congestion (e.g., based on per-device utilization metrics) while being unchanged for other devices in the same service category, thereby protecting users within the same service category from excessive usage. By way of example, a FWS user consuming 150 Mb/s in a location where other FWS users are consuming less than 30 Mb/s can be limited to 50 Mb/s in order to avoid limiting all FWS users in the area to a lower throughput.

Other adjustments are also possible.

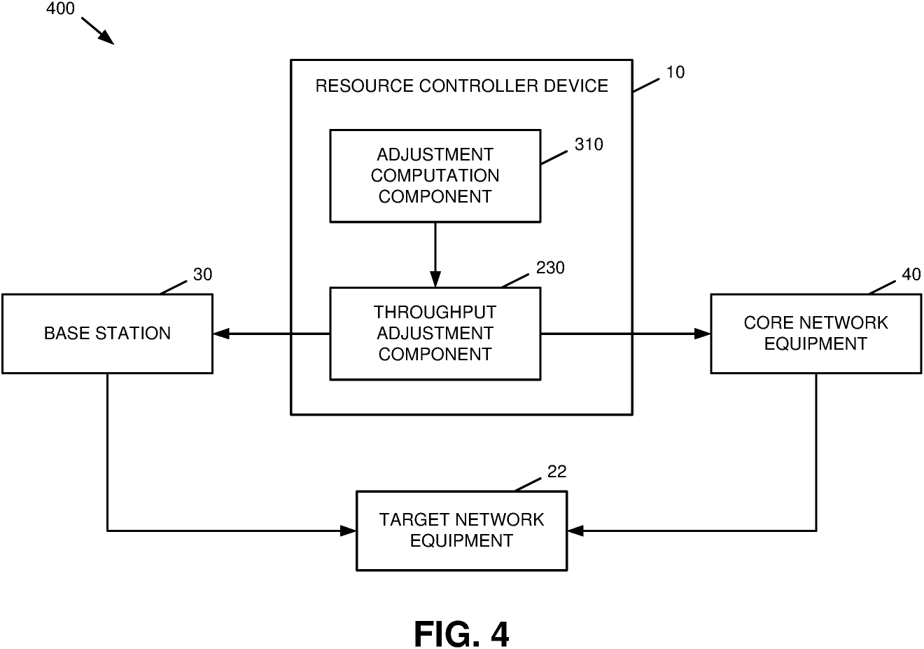

With reference now to FIG. 4, a block diagram of a system 400 that further facilitates distributed computation and enforcement of network throughput adjustments is illustrated. Repetitive description of like elements employed in other embodiments described herein is omitted for brevity. As shown in FIG. 4, in response to the adjustment computation component 310 of the resource controller device 10 determining a throughput adjustment amount(s) for selected target network equipment 22, the throughput adjustment component 230 of the resource controller device 10 can provide throughput adjustment requests that indicate the relevant adjustment amount(s) to respective network elements, which can in turn adjust the throughput of the target network equipment 22 according to the requests. For simplicity of illustration, FIG. 4 depicts an implementation in which the target network equipment 22 corresponding to the adjustment requests has been chosen, e.g., by a device selection component 220 from among a group of network equipment 20 as described above with respect to FIG. 3, prior to the operation of system 400 as shown in FIG. 4.

In the implementation shown by FIG. 4, the resource controller device 10 can submit requests for uplink and downlink throughput adjustment as separate requests to separate network elements. For instance, the resource controller device 10 of system 400 can transmit an uplink throughput adjustment amount corresponding to target network equipment 22 to a base station 30 or other access point serving the target network equipment 22, which can in turn cause and/or configure the base station 30 to adjust the uplink throughput of the target network equipment 22 by the uplink throughput adjustment amount. Similarly, the resource controller device 10 of system 400 can transmit a downlink throughput adjustment amount for the target network equipment 22 to core network equipment 40 associated with a communication network in which the target network equipment 22 operates, which can in turn cause and/or configure the core network equipment 40 to adjust the downlink throughput of the target network equipment 22 by the downlink throughput adjustment amount.

While the implementation shown in FIG. 4 depicts a base station 30 that processes uplink throughput adjustment and core network equipment 40 that processes downlink throughput adjustment, it is noted that other network elements could facilitate throughput adjustment for the target network equipment 22 in addition to, or in place of, these network elements.

Turning now to FIGS. 5-6, diagrams 500, 600 depicting respective network environments that can be utilized for distributed computation and enforcement of network throughput adjustments, e.g., network environments in which the embodiments shown in FIGS. 3-4 can function, are illustrated. It is noted, however, that other network environments could also be used. Additionally, while diagrams 500, 600 relate to AMBR adjustment, it is noted that other throughput measures could be adjusted in a similar manner.

With reference first to diagram 500 in FIG. 5, RAN nodes, such as an eNB or gNB 510, can pass data relating to respective network equipment served by the eNB/gNB 510, network conditions, or the like to a data collection and analytics system 520. The data collection and analytics system 520 can utilize the provided data to generate standardized performance metrics, such as key performance indicators (KPIs), as described above. In one implementation, the eNB/gNB 510 can generate trace data corresponding to respective RAN-layer network events associated with the eNB/gNB 510, and the data collection and analytics system 520 can ingest this trace data to generate performance metrics. Other implementations could also be used.

The KPIs or other metrics generated by the data collection and analytics system 520 can then be exposed to an application function 530, which can be utilized to implement some or all of the functionality of the resource controller device 10 as described above. For instance, the application function 530 can use the exposed metrics to identify specific cells, sector faces, or other network regions where load should be reduced, and to identify respective devices served in the respective identified network regions as well as the active sessions on those devices. The application function 530 can use this information, along with data associated with device registration and session establishment and/or other data identifying related service categories, to determine target devices and/or session for AMBR changes and to calculate the new AMBR levels for these devices and/or sessions.

As further shown in diagram 500, the application function 530 can pass device- and/or session-level AMBR change requests to one or more mobile core nodes 540, such as a 5G Core (5GC) Network Exposure Function (NEF), which can apply and enforce the corresponding policy rules. These rules can include, e.g., passing the per-device and/or per-session AMBR information to the appropriate RAN nodes, such as the eNB/gNB 510, for appropriate enforcement. Also or alternatively, the application function 530 can pass device-level AMBR change requests directly to the eNB/gNB 510 and/or other RAN nodes for enforcement.

In the network environment shown by diagram 500, AMBR enforcement can be split between the eNB/gNB 510 and the mobile core 540 such that the eNB/gNB 510 performs device-level AMBR enforcement (e.g., via a UE-AMBR enforcement module 512) and uplink session-level AMBR enforcement (e.g., via a UL-APN-AMBR enforcement module 514), while the mobile core 540 performs downlink session-level AMBR enforcement (e.g., via a DL-APN-AMBR enforcement module 542). Other enforcement schemes could also be used.

The application function 530 shown in diagram 500 can be implemented via a computing device, e.g., a server or other computing device comprising a processor and a memory, and/or by multiple computing devices, e.g., in a distributed computing environment. Also or alternatively, the application function 530 can be implemented via a cloud computing system that can send and receive data from other network elements in FIG. 5 via application programming interfaces (APIs) or the like.

Referring next to FIG. 6, diagram 600 depicts a network environment that expands upon the functionality discussed above with respect to the network environment shown in diagram 500 by additionally incorporating data indicative of core and transport network conditions. As shown in diagram 600, in addition to RAN and/or device data provided by the eNB/gNB 510 to the data collection and analytics system 520 as described above, the data collection and analytics system 520 can receive transport network data from an associated backhaul transport network 610 as well as core network data from the mobile core 540. The data collection and analytics system 520 can then generate KPIs and/or other performance metrics associated with the transport data and/or core data in a similar manner to that described with respect to diagram 500 for RAN and/or device data, which can in turn be utilized by the application function 530 to generate AMBR change requests, e.g., as described above.

By utilizing data relating to the backhaul transport network 610 and the mobile core 540 in addition to RAN and device data, the application function 530 can further improve the performance of the network environment by enabling throughput adjustments to be performed in response to the presence of core network congestion and/or transport congestion, even in cases in which no RAN congestion is present.

Turning now to FIG. 7, a block diagram of a system 700 that facilitates localized computation and enforcement of network throughput adjustments is illustrated. Repetitive description of like elements employed in other embodiments described herein is omitted for brevity. System 700 as shown in FIG. 7 includes a resource controller device 10 that can generate and process equipment performance metrics to facilitate adjustment of throughput of selected target network equipment 22. In contrast to the resource controller device 10 as shown in FIGS. 3-4, the resource controller device 10 of system 700 can be implemented in a RAN associated with the target network equipment 22, e.g., at a base station serving the target network equipment 22 and/or other RAN elements, instead of as a standalone application.

The resource controller device 10 shown in system 700 includes a usage monitor component 710 that can generate resource usage data representative of respective amounts of network resources (e.g., resources enabled via a communication network) that are being utilized by respective network equipment, e.g., network equipment 20 as shown in FIG. 1 that includes target network equipment 22. In an aspect, the resource usage data generated by the usage monitor component 710 can be similar to the usage data described above with respect to FIG. 3 that is provided by a base station 30 to the resource controller device 10 of system 300. In an implementation in which the resource controller device 10 of system 700 is implemented via a base station or other network access point, the resource usage data generated by the usage monitor component 710 can include internally generated data relating to the operation of the base station and/or the network equipment served by the base station.

As further shown in FIG. 7, the resource controller device 10 of system 700 further includes an adjustment computation component 310 that can determine equipment performance metrics corresponding to the resource usage data generated by the usage monitor component 710. In addition, the adjustment computation component 310 of system 700 can determine an amount to which the throughput of target network equipment 22 selected by the device selection component 220 can be reduced, e.g., in a similar manner to that described above with respect to FIG. 3. Subsequently, the throughput adjustment component 230 of system 700 can facilitate directly adjusting the throughput of the target network equipment 22 by the determined adjustment amount, e.g., by transmitting a throughput adjustment request to the target network equipment 22, or by locally enforcing the throughput change at the resource controller device 10 in an implementation in which the resource controller device 10 is associated with a base station serving the target network equipment 20.

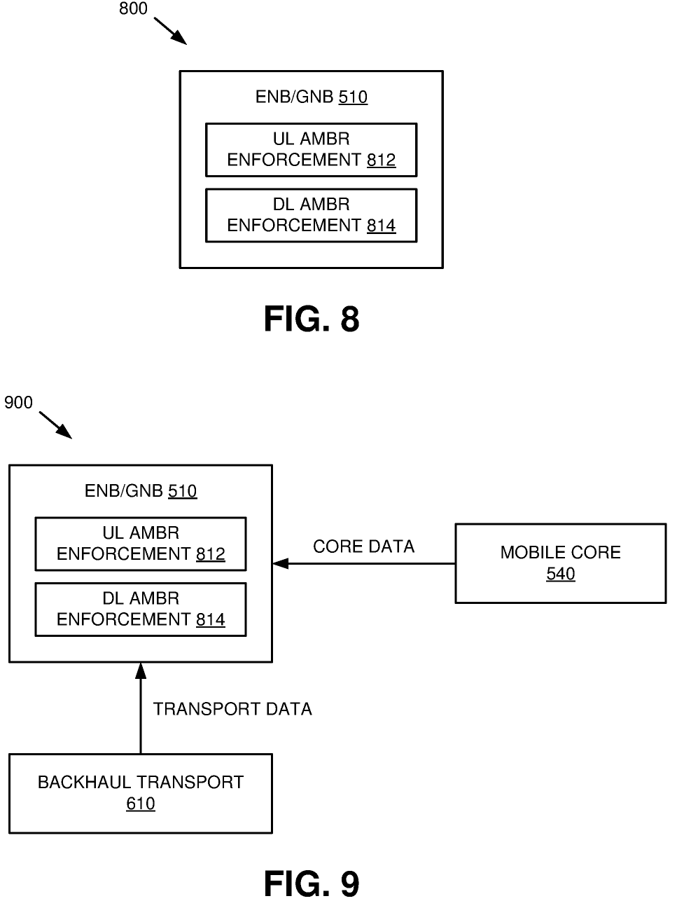

Turning now to FIGS. 8-9, diagrams 800, 900 depicting respective network environments that can be utilized for localized computation and enforcement of network throughput adjustments, e.g., network environments in which the embodiment shown in FIG. 7 can function, are illustrated. It is noted, however, that other network environments could also be used. Additionally, while diagrams 800, 900 relate to AMBR adjustment, it is noted that other throughput measures could be adjusted in a similar manner. It is further noted that throughput adjustment as described herein could be performed via a combination of distributed and localized processing, e.g., based on a combination of the network environments shown in FIGS. 5-6 with those shown in FIGS. 8-9.

With reference first to diagram 800 in FIG. 8, RAN nodes, such as an eNB or gNB 510, can utilize internally generated metrics, such as per-cell physical resource block (PRB) utilization, PRB availability, aggregate cell bit rate, or the like, to select cells, sector faces, or other regions of the network for load reduction. The eNB/gNB 510 can identify the specific device(s) served on the identified network regions and use stored data associated with the corresponding device registration(s), such as service profile identifier (SPID), public land mobile network (PLMN) ID, or slice ID to identify served devices for AMBR adjustment.

The eNB/gNB 510, or other associated RAN nodes, can then use an internally-configured algorithm to determine the new AMBR levels for these devices, taking into account the RAN performance metrics. For example, the eNB/gNB 510 can reduce AMBR to a lesser extent at lower levels of congestion and/or to a greater extent at higher levels of utilization. Also or alternatively, the eNB/gNB 510 can increase AMBR at lower levels of congestion. As shown in diagram 800, the eNB/gNB 510 can include modules for enforcing the determined AMBR changes at the device level, such as a UL AMBR enforcement module 812 for uplink AMBR and a DL AMBR enforcement module 814 for downlink AMBR. While not shown in diagram 800, the eNB/gNB 510 could also facilitate session level AMBR enforcement, e.g., based on information received from a mobile core and/or other network elements.

Turning to diagram 900 in FIG. 9, the eNB/gNB 510 as described above with respect to diagram 800 could additionally receive and utilize data from other sources within the network, such as transport data from a backhaul transport network 610 and core data from a mobile core 540, in a similar manner to that described above with respect to FIG. 6. Based on this information, the eNB/gNB 510 shown in diagram 900 can enable throughput adjustments to be performed in response to the presence of multiple types of congestion, including core network and transport network congestion, in a similar manner to the network architecture shown in FIG. 6.

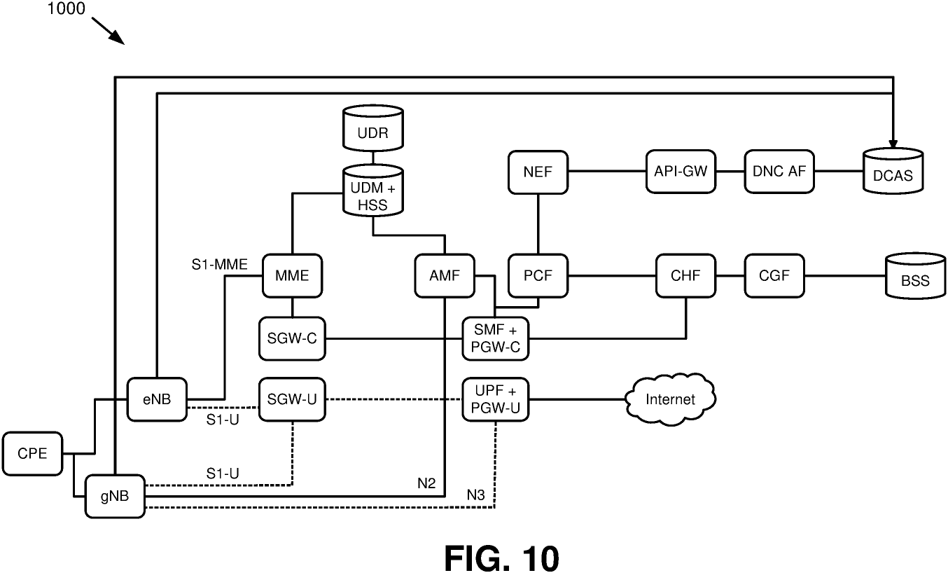

With reference now to FIG. 10, diagram 1000 depicts an example network architecture in which various embodiments described herein can function. It is noted that diagram 1000 is provided merely by way of example, and that other network architectures could also be used. In the network environment shown by diagram 1000, customer premise equipment (CPE), e.g., network equipment 20 as described above, can access the communication network via one or more access points, such as an eNB and/or a gNB. The eNB and/or gNB can facilitate user plane communications via a User Plane Function (UPF) and PDN (Packet Data Network) Gateway User Plane Function (PGW-U) to obtain user plane data from one or more sources, such as the Internet. As shown in diagram 1000, both the eNB and gNB can access the UPF and PGW-U via a Serving Gateway User Plane Function (SGW-U), which can communicate with the UPF and SGW-U via an S1-U interface, while the gNB can also access the UPF and PGW-U directly via an N3 interface.

As additionally shown in diagram 1000, the eNB and/or gNB can facilitate management of user plane communication sessions via a Session Management Function (SMF) and a Packet Data Network (PDN) Gateway Control Plane Function (PGW-C). The eNB can communicate with the SMF and PGW-C via a Mobility Management Entity (MME), via an S1-MME interface, and a Serving Gateway Control Plane Function (SGW-C). Additionally, the gNB can communicate with the SMF and PGW-C via an Access and Mobility Management Function (AMF), via an N2 interface. The SMF and PGW-C can, in turn, access one or more network functions such as a Policy Control Function (PCF) and a Charging Function (CHF). The PCF can provide policy rules to be applied to the user plane communications, e.g., allowing or blocking certain user communication flows or applying different Quality of Service (QoS) rules to certain user communication flows. The CHF can facilitate applying charges to communication services provided by the network, e.g., according to a subscription agreement, based on billing information stored at a Business Support System (BSS) as accessed from the CHF by a Charging Gateway Function (CGF).

The MME and AMF shown in diagram 1000 can interface with Unified Data Management (UDM) and/or a Home Subscriber Service (HSS), e.g., depending on the radio access technologies utilized by the network. The UDM and/or HSS can, based on subscription data stored at a Unified Data Repository (UDR), coordinate control plane operation of the eNB and/or gNB with respect to the CPE.

The eNB and gNB shown in diagram 1000 can further stream trace data to a Data Collection and Analytics System (DCAS), which can generate standardized KPIs and provide initial device and cell-level analysis. A Dynamic Network Control Application Function (DNC AF) can use KPIs provided by the DCAS to determine specific devices for which dynamic QoS controls are to be applied. The DNC AF can identify devices for dynamic QoS control by, e.g., identifying cells at a defined congestion level and identifying the devices using RAN capacity on those cells. Subsequently, the DNC AF can determine when congestion on those cells has decreased sufficiently to restore the devices to their baseline service level. Other techniques could also be used.

The DNC AF can communicate with a Network Exposure Function (NEF) via an API Gateway (API-GW) to apply and/or remove QoS modification to target devices and/or sessions. The DNC AF can apply (and remove) a single reduced throughput level for all controlled devices. Alternatively, the DNC AF can apply different levels of control to different devices in the same area, apply multiple levels of control under different congestion levels, and/or apply additional QoS modifications or other controls via the NEF or at other layers. In an aspect, the control algorithm used by the DNC AF can be made tunable in order to adjust the level of control and how frequently QoS changes are made to devices.

The NEF can receive requests from the DNC AF, authorize the requests, and communicate with the PCF to request the application of policy rules, such as bandwidth changes, to target devices and/or connections. In response to receiving policy authorization requests from the NEF, the PCF can make corresponding policy decisions and send policy updates, including bandwidth changes, for target devices and/or sessions to the SMF + PGW-C. The SMF + PGW-C, upon receiving policy updates from the PDC, can install the appropriate policy rules, including sending session modification requests with new QoS enforcement rules to the UPF + PGW-U.

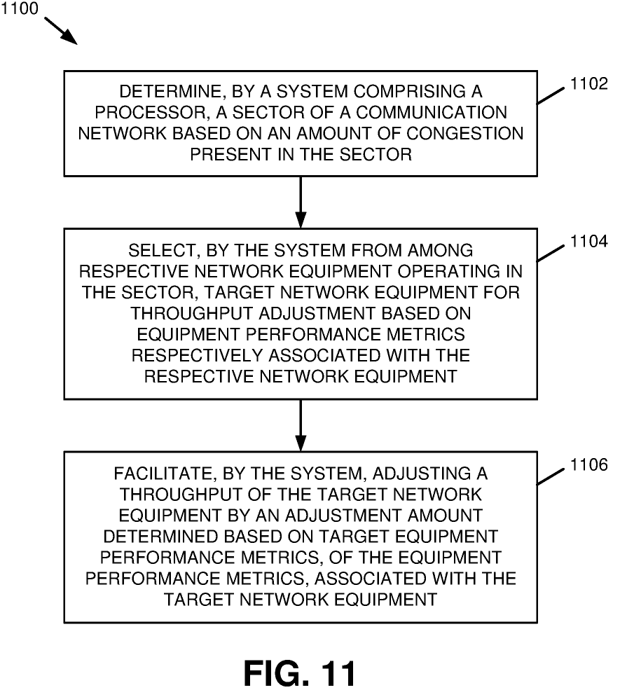

FIG. 11 illustrates a method in accordance with certain aspects of this disclosure. While, for purposes of simplicity of explanation, the method is shown and described as a series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain aspects of this disclosure.

With reference to FIG. 11, a flow diagram of a method 1100 that facilitates dynamic wireless network throughput adjustment is presented. At 1102, a system comprising a processor (e.g., a resource controller device 10 comprising a processor 14, and/or a system including such a device) can determine (e.g., by a network monitor component 210 and/or other components implemented by the processor 14) a sector of a communication network based on an amount of congestion present in the sector.

At 1104, the system can select (e.g., by a device selection component 220 and/or other components implemented by the processor 14), from among respective network equipment (e.g., network equipment 20) operating in the sector, target network equipment (e.g., target network equipment 22) for throughput adjustment based on equipment performance metrics respectively associated with the respective network equipment.

At 1106, the system can facilitate (e.g., by a throughput adjustment component 230 and/or other components implemented by the processor 14) adjusting a throughput of the target network equipment selected at 1104 by an adjustment amount. In an aspect, the adjustment amount can be determined based on target performance metrics, of the equipment performance metrics, that are associated with the target network equipment.

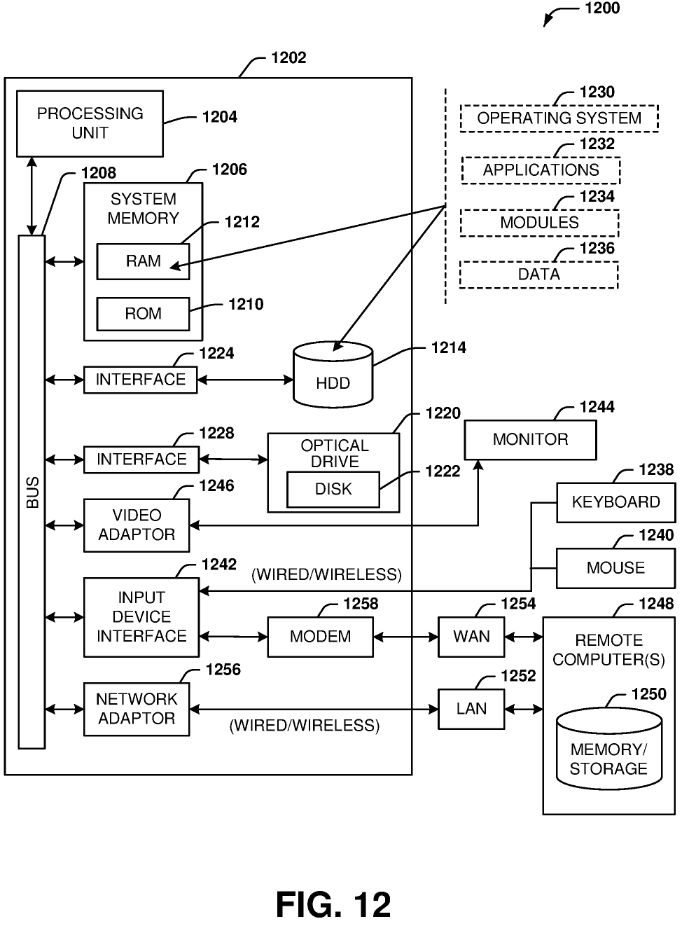

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 and an optical disk drive 1220, (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214 and optical disk drive 1220 can be connected to the system bus 1208 by an HDD interface 1224 and an optical drive interface 1228, respectively. The HDD interface 1224 can additionally support external drive implementations via Universal Serial Bus (USB), Institute of Electrical and Electronics Engineers (IEEE) 1394, and/or other interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) can include a microphone, an infrared (IR) remote control, a joystick, a game pad, a stylus pen, touch screen or the like. These and other input devices are often connected to the processing unit 1204 through an input device interface 1242 that can be coupled to the system bus 1208, but can be connected by other interfaces, such as a parallel port, an IEEE 1394 serial port, a game port, a USB port, an IR interface, a BLUETOOTH® interface, etc.

A monitor 1244 or other type of display device can be also connected to the system bus 1208 via an interface, such as a video adapter 1246. In addition to the monitor 1244, a computer typically includes other peripheral output devices (not shown), such as speakers, printers, etc.

The computer 1202 can operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1252 through a wired and/or wireless communication network interface or adapter 1256. The adapter 1256 can facilitate wired or wireless communication to the LAN 1252, which can also include a wireless access point (AP) disposed thereon for communicating with the wireless adapter 1256.

When used in a WAN networking environment, the computer 1202 can include a modem 1258 or can be connected to a communications server on the WAN 1254 or has other means for establishing communications over the WAN 1254, such as by way of the Internet. The modem 1258, which can be internal or external and a wired or wireless device, can be connected to the system bus 1208 via the input device interface 1242. In a networked environment, program modules depicted relative to the computer 1202 or portions thereof, can be stored in the remote memory/storage device 1250. It will be appreciated that the network connections shown are example and other means of establishing a communications link between the computers can be used.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive - in a manner similar to the term “comprising” as an open transition word - without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
determining, by a system comprising a processor, a sector of a communication network based on an amount of congestion present in the sector;
selecting, by the system from among respective network equipment operating in the sector, target network equipment for throughput adjustment based on equipment performance metrics respectively associated with the respective network equipment; and
facilitating, by the system, adjusting a throughput of the target network equipment by an adjustment amount determined based on target equipment performance metrics, of the equipment performance metrics, associated with the target network equipment.

2. The method of claim 1, further comprising:
obtaining, by the system from a base station serving the respective network equipment, resource usage data representative of respective amounts of resources, enabled via the communication network, being utilized by the respective network equipment; and
determining, by the system, the equipment performance metrics based on the resource usage data.

3. The method of claim 2, wherein the throughput of the target network equipment comprises a downlink throughput, and wherein the facilitating comprises:
transmitting, by the system, the adjustment amount to core network equipment associated with the communication network, causing the core network equipment to adjust the downlink throughput of the target network equipment by the adjustment amount.

4. The method of claim 2, wherein the throughput of the target network equipment comprises an uplink throughput, and wherein the facilitating comprises:
transmitting, by the system, the adjustment amount to the base station serving the respective network equipment, causing the base station to adjust the uplink throughput of the target network equipment by the adjustment amount.

5. The method of claim 1, further comprising:
generating, by the system, resource usage data representative of respective amounts of resources, enabled via the communication network, being utilized by the respective network equipment; and
determining, by the system, the equipment performance metrics based on the resource usage data,
wherein the facilitating comprises adjusting the throughput of the target network equipment by the adjustment amount.

6. The method of claim 1, wherein the congestion present in the sector is determined to be of a type selected from a group of types comprising radio access network congestion, core network congestion, and transport network congestion.

7. The method of claim 1, wherein selecting the target network equipment comprises selecting the target network equipment further based on a location of the target network equipment relative to the sector of the communication network.

8. The method of claim 1, wherein selecting the target network equipment comprises selecting the target network equipment further based on a service category assigned to the target network equipment.

9. The method of claim 1, wherein facilitating the adjusting comprises facilitating the adjusting of a total throughput assigned to the target network equipment by the adjustment amount.

10. The method of claim 1, wherein the facilitating comprises facilitating the adjusting of a first throughput assigned to a first data connection utilized by the target network equipment without adjusting a second throughput assigned to a second data connection, distinct from the first data connection, utilized by the target network equipment.

11. A system, comprising:
a processor; and
a memory that stores executable instructions that, when executed by the processor, facilitate performance of operations, comprising:
determining a sector of a communication network based on an amount of network congestion exhibited by the sector;
selecting, from among respective network devices operating in the sector, a target network device for throughput adjustment based on device performance metrics respectively associated with the respective network devices; and
adjusting a throughput of the target network device by an adjustment amount, wherein the adjustment amount is determined based on a group of the device performance metrics associated with the target network device.

12. The system of claim 11, wherein the operations further comprise:
obtaining, from a network access point serving the respective network devices, resource usage data representative of respective amounts of resources, enabled via the communication network, being utilized by the respective network devices; and
generating the device performance metrics based on the resource usage data.

13. The system of claim 12, wherein the throughput of the target network device comprises a downlink throughput, and wherein the adjusting comprises transmitting the adjustment amount to core network equipment associated with the communication network, causing the core network equipment to adjust the downlink throughput of the target network device by the adjustment amount.

14. The system of claim 12, wherein the throughput of the target network device comprises an uplink throughput, and wherein the adjusting comprises transmitting the adjustment amount to the network access point serving the respective network devices, causing the network access point to adjust the uplink throughput of the target network device by the adjustment amount.

15. The system of claim 11, wherein the operations further comprise:
generating resource usage data representative of respective amounts of resources, enabled via the communication network, being utilized by the respective network devices; and
determining the device performance metrics based on the resource usage data,
wherein the adjusting comprises adjusting the throughput of the target network device by the adjustment amount.

16. A non-transitory machine-readable medium, comprising executable instructions that, when executed by a processor, facilitate performance of operations, comprising:
selecting a cell of a network based on an amount of congestion exhibited by the cell;
selecting, from among respective network equipment operating in the cell, network equipment based on performance metrics respectively associated with the respective network equipment; and
causing adjustment of a throughput of the network equipment by an adjustment amount, the adjustment amount being determined based on ones of the performance metrics associated with the network equipment.

17. The non-transitory machine-readable medium of claim 16, wherein the operations further comprise:
obtaining, from a base station serving the respective network equipment, resource usage data representative of respective amounts of resources, enabled via the network, being utilized by the respective network equipment; and
generating the performance metrics based on the resource usage data.

18. The non-transitory machine-readable medium of claim 17, wherein the throughput of the network equipment comprises a downlink throughput, and wherein the operations further comprise:
transmitting the adjustment amount to core network equipment associated with the network, resulting in the core network equipment being configured to adjust the downlink throughput of the network equipment by the adjustment amount.

19. The non-transitory machine-readable medium of claim 17, wherein the throughput of the network equipment comprises an uplink throughput, and wherein the operations further comprise:
transmitting the adjustment amount to the base station serving the respective network equipment, resulting in the base station being configured to adjust the uplink throughput of the network equipment by the adjustment amount.

20. The non-transitory machine-readable medium of claim 16, wherein the operations further comprise:
generating resource usage data representative of respective amounts of resources, enabled via the network, being utilized by the respective network equipment;
determining the performance metrics based on the resource usage data; and
adjusting the throughput of the network equipment by the adjustment amount.
